(19) United States
(12) Patent Application Publication
(10) Pub. No.: US 2018/0258373 A1
(43) Pub. Date: Sep. 13, 2018

(54) De-Coating Of Corrugated Polymeric Substrates

(71) Applicant: Geo-Tech Polymers, LLC, Westerville, OH (US)

(72) Inventors: Sreevalli Bokka, Chillicothe, OH (US); Ronald L. Whaley, Portsmouth, OH (US)

(21) Appl. No.: 15/916,580

(22) Filed: Mar. 9, 2018

Related U.S. Application Data
(60) Provisional application No. 62/470,122, filed on Mar. 10, 2017.

(51) Int. Cl. C11D 11/00; C11D 1/66; C11D 3/04; C11D 3/34

(52) U.S. Cl. CPC C11D 11/0035; C11D 1/662; C09D 9/04; C11D 3/34; C11D 3/044

(57) ABSTRACT

Compositions, process mixtures, methods, and kits are provided for removing one or more coatings from a polymeric substrate, e.g., corrugated polymeric substrates, using a single-phase aqueous solution. The single-phase aqueous solution may include, for example, water; an inorganic base composition; a sulfoxylate composition; and a surfactant composition.

### CROSS-REFERENCE TO RELATED APPLICATIONS

This application claims priority to U.S. Provisional Pat. App. No. 62/470,122 filed on Mar. 10, 2017, which is entirely incorporated herein by reference herein.

### BACKGROUND

Polymeric substrates, such as plastic regrind or shredded film formed in recycling processes, may include undesirable coatings. For example, textile laminates on polymeric substrates, such as a textile laminated to a corrugated polymeric substrate by an adhesive, and the like. It is desirable to process such polymeric substrates to remove undesired coatings prior to further uses of the substrates, such as recycled feedstocks for plastic article manufacture. Existing processes use extremely caustic solutions, high temperatures and/or pressures, or costly reagents to remove coatings. Even so, removing coatings from corrugated polymeric substrates may be difficult.

The present application appreciates that removing coatings from polymeric substrates may be a challenging endeavor.

### SUMMARY

In one embodiment, a single-phase aqueous solution for removing one or more coatings from a polymeric substrate is provided. The single-phase aqueous solution may include water, an inorganic base composition, a sulfoxylate composition, and a surfactant composition.

In another embodiment, a method for removing one or more coatings from a polymeric substrate is provided. The method may include providing a single-phase aqueous solution. The single-phase aqueous solution may include water; an inorganic base composition; a sulfoxylate composition; and a surfactant composition. The method may include providing a polymeric substrate. The polymeric substrate may include one or more coatings. The method may include contacting the single-phase aqueous solution and the polymeric substrate to form a process mixture under conditions effective to remove at least a portion of the one or more coatings from the polymeric substrate.

In one embodiment, a method for removing one or more coatings from a corrugated polymeric substrate is provided. The method may include providing a single-phase aqueous solution. The single-phase aqueous solution may include water, an inorganic base composition, and a surfactant composition. The single-phase aqueous solution may include one or more of a stable peroxygen composition, a monosaccharide salt, and a sulfoxylate composition. The method may include providing the corrugated polymeric substrate. The corrugated polymeric substrate may include one or more coatings. The method may include contacting the single-phase aqueous solution and the corrugated polymeric substrate to form a process mixture under conditions effective to remove at least a portion of the one or more coatings from the corrugated polymeric substrate.

In another embodiment, a kit for removing one or more coatings from a polymeric substrate is provided. The kit may include a single-phase aqueous solution. The single-phase aqueous solution may include a surfactant composition and a sulfoxylate composition. The kit may include an inorganic base composition. The kit may include instructions. The instructions may direct a user to add the inorganic base composition to the single-phase aqueous solution. The instructions may direct a user to provide a polymeric substrate. The polymeric substrate may include one or more coatings. The instructions may direct a user to contact the single-phase aqueous solution and the polymeric substrate to form a process mixture under conditions effective to remove at least a portion of the one or more coatings from the polymeric substrate.

### DETAILED DESCRIPTION

The present application relates to compositions, process mixtures, kits, and methods for removing one or more coatings from a polymeric substrate, e.g., corrugated polymer substrates, laminates of textile and adhesive on polymer substrates, e.g., corrugated packaging polymer substrates, soft plastic or rubber overmolds on polymer substrates, and the like.

In various embodiments, a single-phase aqueous solution is provided. The single-phase aqueous solution may be used for removing one or more coatings from a polymeric substrate. The single-phase aqueous solution may include water, an inorganic base composition, a sulfoxylate composition, and a surfactant composition.

In several embodiments, the inorganic base composition may include one or more of: an alkali metal hydroxide, an alkaline earth metal oxide, or an alkaline earth metal hydroxide. Further, the inorganic base composition may consist of, or may consist essentially of, one or more of: the alkali metal hydroxide, the alkaline earth metal oxide, or the alkaline earth metal hydroxide. As used herein, alkali metals may include, for example, lithium, sodium, potassium, rubidium, or cesium. Alkaline earth metals may include, for example, beryllium, magnesium, calcium, strontium, or barium. For example, the inorganic base composition may include one or more of: lithium hydroxide, sodium hydroxide, potassium hydroxide, magnesium oxide, calcium oxide, magnesium hydroxide, or calcium hydroxide. The inorganic base composition may consist of, or may consist essentially of, one or more of: lithium hydroxide, sodium hydroxide, potassium hydroxide, magnesium oxide, calcium oxide, magnesium hydroxide, and calcium hydroxide. The inorganic base composition may include sodium hydroxide. The inorganic base composition may consist of, or may consist essentially of, sodium hydroxide.

In some embodiments, the inorganic base composition may be present in an amount effective to establish a desired hydroxide concentration in the single-phase aqueous solution. For example, the desired hydroxide concentration may have a molarity in moles/L (M) of: from about 0.0125 to about 0.625, from about 0.025 to about 0.5, from about 0.025 to about 0.375, from about 0.025 to about 0.25, from about 0.025 to about 0.125, about 0.125, about 0.0625, or a value or range of values based on any of the preceding, for example, from about 0.0125 to about 0.625, from about 0.025 to about 0.25, or about 0.125. For example, for sodium hydroxide, a molarity from about 0.025 to about 0.25 may correspond to a weight percentage (w/w) with respect to the water of from about 0.05% to about 2.5%, e.g., about 0.5%, about 1%, or about 0.375% sodium hydroxide.

In some embodiments of the single-phase aqueous solution, the sulfoxylate composition may include a salt of hydroxymethylene sulfoxylate with an 10n of one of: an alkali metal, an alkali earth metal, and a transition metal. Examples of such salts include sodium hydroxymethylene sulfoxylate, calcium hydroxymethylene sulfoxylate, zinc hydroxymethylene sulfoxylate, and the like. For example, the sulfoxylate composition may include sodium hydroxymethylene sulfoxylate. The sulfoxylate composition may be present in a weight percentage (w/w) with respect to water of about one or more of: 0.05% to 5%, 0.05 to 2.5%, 0.1% to 2%, 0.15% to 1.5%, 0.2% to 1%, 0.3% to 0.7%, 0.4% to 0.6%, and 0.5%. The sulfoxylate composition may include compositions sold under the tradename BRUGGOLITE® (Bruggemann Chemical; Newtown Square, Pa.), e.g., BRUGGOLITE® FF6M. The sulfoxylate composition may include compositions sold under the tradename RONGALITE' (BASF Corporation, Florham Park, N.J.).

In various embodiments, the single-phase aqueous solution may include one or more of a stable peroxygen composition and a monosaccharide salt.

In several embodiments, the stable peroxygen composition may include an alkali metal salt of one or more of: peroxide, percarbonate, persulfate, or perborate. The stable peroxygen composition may consist of, or may consist essentially of, the alkali metal salt of one or more of: peroxide, percarbonate, persulfate, or perborate. For example, the stable peroxygen composition may include sodium percarbonate. The stable peroxygen composition may consist of, or may consist essentially of, the sodium percarbonate.

In various embodiments, the stable peroxygen composition may be present in an amount effective to provide peroxide in a molar ratio to hydroxide from the inorganic base composition. The molar ratio may between about 0.5:1 to about 1.5:1, between about 0.55:1 to about 1.4:1, between about 0.6:1 to about 1.3:1, between about 0.65:1 to about 1.2:1, between about 0.7:1 to about 1.1:1, between about 0.7:1 to about 1:1, between about 0.7:1 to about 0.9:1, between about 0.7:1 to about 0.8:1, about 0.75:1, or a range between about any two of the preceding values, or about any of the preceding values. The stable peroxygen composition may be present in an amount effective to provide a peroxide concentration. The peroxide concentration may have a value in millimoles per liter (mM) of from about 9.55 mM to about 478 mM. In several embodiments, the peroxide concentration in millimoles per liter (mM) may be calculated from the hydroxide concentration based on the above molar ratios of peroxide to hydroxide. In several embodiments, the stable peroxygen composition, e.g., sodium percarbonate, may be in a weight percentage (w/w) with respect to the water of about one or more of: 0.1% to 5%, 0.2% to 2.5%, 0.3 to 2%, 0.5% to 1.5%, 0.75% to 1.25%, and 1%. The stable peroxygen composition may consist of, or may consist essentially of, sodium percarbonate in a weight percentage (w/w) with respect to the water of from about 0.01% to about 0.5%. The stable peroxygen composition may include sodium percarbonate in a weight percentage (w/w) with respect to the water of about 1%. In several embodiments, the single-phase aqueous solution may exclude the stable peroxygen composition.

In many embodiments, the single-phase aqueous solution may include a monosaccharide salt. The single-phase aqueous solution may include a salt of an oxidized monosaccharide. For example, the single-phase aqueous solution may include a salt of glucose, galactose, mannose, fructose, ribose, arabinose, and the like. For example, the single-phase aqueous solution may include a salt of oxidized glucose (e.g., gluconic acid), galactose, mannose, fructose, ribose, arabinose, and the like. As used herein, a salt may include a cationic species and an anionic species. For example, an anionic species may include one or more of: a carboxylate and an alkoxide. The cation may include, for example, an alkali metal, an alkaline earth metal, a transition metal, a protonated amine, and the like. For example, the cation may include Li⁺, Na⁺, K⁺, Cs⁺, Ca²⁺, Mg²⁺, Fe²⁺, Zn²⁺, quinine, and the like.

The monosaccharide salt may be present in the single-phase aqueous solution in a weight percentage (w/w) with respect to the water of one or more of: 0.01, 0.02, 0.05, 0.10, 0.20, 0.30, 0.40, 0.50, 0.60, 0.70, 0.80, 0.90, 1.0, 1.2, 1.4, 1.6, 1.8, 2.0, 2.4, 2.6, 3.0, 3.3, 3.6, 4.0, 4.2, 4.5, 4.7, and 5.0. The monosaccharide salt may be present in the single-phase aqueous solution in a weight percentage (w/w) between any of the preceding values, for example, between about 0.5 and about 1.0, or between about 0.70 and about 2.4, and the like. The monosaccharide salt may be present in the single-phase aqueous solution in a weight percentage (w/w) with respect to the water of about 1.

In many embodiments, the single-phase aqueous solution may include a monosaccharide salt and exclude a stable peroxygen composition. In some embodiments, the single-phase aqueous solution may include a monosaccharide salt and a stable peroxygen composition. For example, the single-phase aqueous solution may include 1% (w/w) sodium and 1% (w/w) sodium gluconate, each with respect to water.

The monosaccharide salt may be present in a weight percent concentrations (w/w) with respect to water of about one or more of: 0.1% to 5%, 0.2% to 2.5%, 0.3 to 2%, 0.5% to 1.5%, 0.75% to 1.25%, and 1%. The monosaccharide salt may include sodium gluconate.

In several embodiments, the single-phase aqueous solution may include the surfactant composition in a in a weight percentage (w/w) with respect to the water of one or more of about: 0.005% to 2%; 0.01 to 1.5%; 0.025% to 1%; 0.025% to 0.75%; 0.025% to 0.5%; 0.05% to 0.25%; 0.05% to 0.15%; 0.2%; and 0.1%.

In some embodiments, the surfactant composition may include a nonionic surfactant. The surfactant composition may consist essentially of, or may consist of nonionic surfactants. For example, as used herein, the one or more alkylglycosides may be nonionic surfactants. The surfactant composition may include two or more of the alkylglycosides. Each alkyl in the alkylglycosides, e.g., the one or more alkylglycosides, may be independently selected from one of: C₄-C₂₀ alkyl; C₆-C₁₈ alkyl; C₆-C₁₄ alkyl; C₆-C₁₂ alkyl; C₈-C₁₀ alkyl; or C₈ and C₁₀ alkyl. The one or more alkylglycosides may include one or more alkylglucosides, e.g., two or more alkylglucosides. Each alkyl in the alkylglucosides, e.g., the one or more alkylglucosides, may be independently selected from one of: C₄-C₂₀ alkyl; C₆-C₁₈ alkyl; C₆-C₁₄ alkyl; C₆-C₁₂ alkyl; C₈-C₁₀ alkyl; or C₈ and C₁₀ alkyl. The one or more alkylglycosides may include one or more of capryl glucoside or decyl glucoside. The surfactant composition may include a surfactant blend. For example, the surfactant composition may include a nonionic surfactant blend of C₈-C₁₀ alkylglycoside surfactant and a C₆-C₁₂ polyalkylene glycol alkyl ether surfactant.

In some embodiments, the surfactant composition may include an alkylglycoside. Each alkyl may be independently selected from C₆-C₈ alkyl. For example, the alkylglycoside may include one or more of: capryl glucoside, decyl glucoside, deceth-5, and PPG-6-Laureth-3. The surfactant composition being present in a weight percentage (w/w) with respect to the water of one or more of about: 0.005% to 5%, 0.01 to 4%, 0.05% to 3%, 0.1% to 2%, 0.5% to 1.5%, and 1%.

In several embodiments, the surfactant composition may also include one or more of: a polyalkylene glycol alkyl ether, a polyethylene glycol alkyl ether, a polypropylene glycol alkyl ether, and a polypropylene glycol polyethylene glycol alkyl ether. A polyalkylene glycol alkyl ether may be referred to herein as an alkoxylated alcohol, e.g., ethoxylated alcohol, propoxylated alcohol, or a combination thereof, and the like. The polyalkylene glycol alkyl ether may be represented by R¹—(OR²)ₓ—OH. The group represented by R¹ may be, for example, C₆-C₁₆ alkyl. R¹ may be derived from one or more of: a primary alcohol, a secondary alcohol, a tertiary alcohol, a linear alkyl alcohol, and a branched alkyl alcohol. The group represented by R² may be C₂-C₄ alkyl, e.g., ethylene or substituted ethylene. The variable x may be an integer from 1 to 10. In some embodiments, the group represented by R¹ may be C₈-C₁₂ alkyl; the group represented by R² may be ethyl; and the variable x may be an integer from 3 to 7.

The polypropylene glycol polyethylene glycol alkyl ether may be represented by R³—(OR⁴)_{y}—(OR⁵)_{z}—OH, R³—(OR⁵)_{z}—(OR⁴)_{y}—OH, R³—(OR⁴)_{y}—(OR⁵)_{z}—(OR⁴)—OH, R³—(OR⁵)_{z}—(OR⁴)_{y}——(OR⁵)_{z}—OH, a combination thereof, or the like. R³ may be, for example, C₆-C₂₀ alkyl. R³ may be derived from one or more of: a primary alcohol, a secondary alcohol, a tertiary alcohol, a linear alkyl alcohol, and a branched alkyl alcohol. The group represented by R⁴ may be C₂, e.g. ethylene. The variable y may be an integer from 1 to 12. The groups represented by R⁵ may be C₃, e.g. ethylene substituted with a methyl group. The variable z may be an integer from 1 to 30, e.g., 1 to 12. In some embodiments, the variable z may be an integer from 4 to 8; the variable y may be an integer from 1 to 5; and the group represented by R³ may be C₁₀-C₁₄ alkyl.

In various embodiments, suitable examples of polyalkylene glycol alkyl ethers may include Deceth-x class nonionic surfactants, e.g., represented by R¹—(OR²)ₓ—OH, where the group represented by le is decyl; the group represented by R² is ethyl; and the variable x may be an integer from 1 to 10. For example, one suitable example may be Deceth-5. Other examples of polyalkylene glycol alkyl ethers may include LPS-T91™ (LPS Laboratories, a division of Illinois Tool Works, Inc., Tucker, Ga.); ETHYLAN™ 1005 SA, ETHYLAN™ 1206, ETHYLAN™ TD-60, ETHYLAN™ 324, ETHYLAN™ 954, ETHYLAN™ 1008 SA, ETHYLAN™ 992, ETHYLAN™ 995, ETHYLAN™ NS 500 K, ETHYLAN™ NS 500 LQ, ETHYLAN™ SN-120, ETHYLAN™ SN-90, ETHYLAN™ TD-1407 (AzkoNobel Surface Chemistry LLC, Chicago, Ill.); TERGITOL™ 15-S-9, TERGITOL™ 15-S-3, TERGITOL™ 15-S-5, TERGITOL™ 15-S-7, TERGITOL™ 15-S-12, TERGITOL™ 15-S-15, TERGITOL™ 15-S-20, TERGITOL™ 15-S-30, TERGITOL™ 15-S-40 (Dow Chemical Company, Midland, Mich.); TOMADOL® 1200, TOMADOL® 91-8, TOMADOL® 1-9, TOMADOL® 1-3, TOMADOL® 1-5, TOMADOL® 1-7, TOMADOL® 1-73B, TOMADOL® 23-1, TOMADOL® 23-3, TOMADOL® 23-6.5, TOMADOL® 25-12, TOMADOL® 25-3, TOMADOL® 25-7, TOMADOL® 25-9, TOMADOL® 45-13, TOMADOL® 45-7, TOMADOL® 600, TOMADOL® 900, TOMADOL® 901, TOMADOL® 902, TOMADOL® 910, TOMADOL® 91-2.5, and TOMADOL® 91-6 (Air Products and Chemicals, Inc., Allentown, Pa.).

Suitable examples of polypropylene glycol polyethylene glycol alkyl ethers may include the PPG-z-Laureth-y class nonionic surfactants, e.g., represented by R³-(0R⁴)y-(0R⁵)z-OH or R³—(0R⁵)z-(0R⁴)y-OH, where the group represented by R³ is lauryl, the group R⁴ represents ethylene, the variable z may be an integer from 1 to 12, e.g., 1 to 5; the group R⁵represents propylene (propylene glycol, PPG), e.g., ethylene substituted with a methyl group, and variable z may be an integer from 1 to 30, e.g., 1 to 12, or 4 to 8. For example, one suitable example may be PPG-6-Laureth-3.

In several embodiments, the surfactant composition may include one or more of:

Deceth-5 and PPG-6-Laureth-3. The surfactant composition may include: capryl glucoside, decyl glucoside, Deceth-5, and PPG-6-Laureth-3. The surfactant composition may consist essentially of: capryl glucoside, decyl glucoside, Deceth-5, and PPG-6-Laureth-3. The surfactant composition may consist of: capryl glucoside, decyl glucoside, Deceth-5, and PPG-6-Laureth-3.

In various embodiments, suitable surfactant compositions including nomomc surfactants such as the one or more alkylglycosides, may include, for example, the alkylglucoside compositions sold under the tradename DEHYPOUND® (e.g., DEHYPOUND® Advanced, and the like, BASF Corporation, Florham Park, N.J.). For example, DEHYPOUND® Advanced may include caprylyl glucoside and decyl glucoside. For example, DEHYPOUND® Advanced may be employed in a weight percentage of from about 0.005% to about 2%, e.g., about 0.3%. Suitable surfactant compositions may include polyalkylene glycol alkyl ether or a polypropylene glycol polyethylene glycol alkyl ether surfactants. For example, DEHYPOUND® Advanced may include Deceth-5 and PPG-6-Laureth-3.

In various embodiments, the surfactant composition may include two or more alkyl polyglycosides. The surfactant composition may consist of, or may consist essentially of, the two or more alkyl polyglycosides. The surfactant composition may include at least one alkyl polyglucoside. The surfactant composition may consist of, or may consist essentially of, the at least one alkyl polyglucoside. The surfactant composition may include one or more alkyl polyglycosides. The surfactant composition may consist of, or may consist essentially of, the one or more alkyl polyglycosides. Each alkyl in the one or more alkyl polyglycosides may be independently selected from C₆-C₁₈ alkyl. Each alkyl in the one or more alkyl polyglycosides may be independently derived from a fatty alcohol derivative of coconut oil or palm kernel oil. Each alkyl in the one or more alkyl polyglycosides may be independently selected from C₈-C₁₆ alkyl. The surfactant composition may include two or more alkyl polyglucosides. The surfactant composition may consist of, or may consist essentially of, the two or more alkyl polyglucosides. The surfactant composition may include a C₈-C₁₀ alkyl polyglucoside and a C₁₀-C₁₆ alkyl polyglucoside. The surfactant composition may consist of, or may consist essentially of, the C₈-C₁₀ alkyl polyglucoside and the C₁₀-C₁₆ alkyl polyglucoside. The surfactant composition may include a weight ratio of a C₈-C₁₀ alkyl polyglucoside to a C₁₀-C₁₆ alkyl polyglucoside. The weight ratio may be, for example, between about 1:5 and about 2:3.

The surfactant composition may include two or more alkyl polyglucosides. The surfactant composition may consist of, or may consist essentially of, the two or more alkyl polyglucosides. The surfactant composition may include a C₈-C₁₀ alkyl polyglucoside and a C₁₀-C₁₆ alkyl polyglucoside. The surfactant composition may consist of, or may consist essentially of, the C₈-C₁₀ alkyl polyglucoside and the C₁₀-C₁₆ alkyl polyglucoside. The surfactant composition may include a weight ratio of a C₈-C₁₀ alkyl polyglucoside to a C₁₀-C₁₆ alkyl polyglucoside. The weight ratio may be, for example, between about 1:5 and about 2:3.

In various embodiments, the one or more alkyl polyglycosides in the surfactant composition may be present in the single-phase aqueous solution in a weight percentage (w/w) with respect to the water of one or more of: from about 0.01 to about 0.5, from about 0.025 to about 0.4, from about 0.05 to about 0.3, from about 0.075 to about 0.25, from about 0.1 to about 0.2, about 0.15, or a value or range of values based on any of the preceding, for example, from about 0.01% to about 0.5% or about 0.15%. Suitable alkyl polyglycoside compositions may include, for example, compositions sold under the tradename GLUCOPON®, e.g., GLUCOPON® 420UP, GLUCOPON® 425N, and the like. (BASF Corporation, Florham Park, NJ). For example, GLUCOPON® 420UP may be employed in a weight percentage of from about 0.01% to about 0.5%, e.g., about 0.15%. Suitable alkyl polyglycoside compositions may include two or more alkyl polyglycosides, for example, GLUCOPON® 420UP may include caprylyl (C₈) glucoside and myristyl (C₁₄) glucoside.

The single-phase aqueous solution may include the water in a weight percent (w/w) of the single-phase aqueous solution of at least about one or more of: 90%, 91%, 92%, 93%, 94%, 95%, 96%, 97%, 98%, 99%, 99.1%, 99.2%, 99.25%, 99.3%, or 99.35%, for example, at least about 95% by weight of water.

In various embodiments, the single-phase aqueous solution may be characterized by a pH value of about one or more of: 10 to 14; 10.5 to 14; 11 to 14; 11.5 to 14; 12 to 14; or 12.5 to 13.5. For example, the single-phase aqueous solution may be characterized by a pH of about 11.3.

In various embodiments, a method for removing one or more coatings from a polymeric substrate is provided. The method may include providing a single-phase aqueous solution. The single-phase aqueous solution may include water; an inorganic base composition; a sulfoxylate composition; and a surfactant composition. The method may include providing a polymeric substrate. The polymeric substrate may include one or more coatings. The method may include contacting the single-phase aqueous solution and the polymeric substrate to form a process mixture under conditions effective to remove at least a portion of the one or more coatings from the polymeric substrate.

In several embodiments, the method may include providing a precursor single-phase aqueous solution. The precursor single-phase aqueous solution may include: water; a precursor inorganic base composition; one or more of a precursor stable peroxygen composition and a precursor monosaccharide salt; and a precursor surfactant composition. Each of the precursor inorganic base composition, the precursor stable peroxygen composition, the precursor monosaccharide salt, and the precursor surfactant composition may be independently and respectively selected from the inorganic base composition, the stable peroxygen composition, the monosaccharide salt, and the surfactant composition as described herein. The precursor single- phase aqueous solution may include the water, the precursor inorganic base composition, the precursor stable peroxygen composition the precursor monosaccharide salt, and the precursor surfactant composition in an amount independently selected from amounts described herein for the respective components of the single-phase aqueous solution. The method may include, prior to contacting the single-phase aqueous solution and the polymeric substrate to form the process mixture, contacting the precursor single-phase aqueous solution to the polymeric substrate may include the one or more coatings to form a precursor process mixture under conditions effective to remove at least a portion of the one or more coatings from the polymeric substrate. The method may include separating the polymeric substrate from the precursor process mixture prior to contacting the single-phase aqueous solution and the polymeric substrate to form the process mixture.

In various embodiments, a process mixture is provided, as produced by any method described herein. In some embodiments, a precursor process is provided, as produced by any method described herein.

In various embodiments, the conditions effective to remove a portion of the one or more coatings from the polymeric substrate may include heating the process mixture. The process mixture may be heated may be heated at a temperature of about one or more of: between about 10° C. and about 100° C.; between about 10° C. and about 30° C. or between about 15° C. and 26° C. Alternatively, between about 65° C. and about 100° C.; between about 70° C. and about 100° C.; between about 75° C. and about 95° C.; between about 80° C. and about 90° C.; between about 80° C. and about 85° C.; about 85° C.; about 82° C.; or between about any two of the preceding values, or about any of the preceding values, for example, between about 60° C. and about 100° C. or about 85° C.

In several embodiments, the method may include providing the water in the single-phase aqueous composition in a weight ratio to the polymeric substrate of one or more of about: 4:1 to 32:1; 8:1 to 24:1; 10:1 to 20:1; 12:1 to 18:1; 14:1 to 18:1; 15:1 to 17:1; and 16:1. The method may include providing the water in the precursor single-phase aqueous composition in a weight ratio to the polymeric substrate of one or more of about: 4:1 to 32: 1; 8:1 to 24:1; 10:1 to 20:1; 12:1 to 18:1; 14:1 to 18:1; 15:1 to 17:1; and 16:1.

In various embodiments, the method may include monitoring the process mixture for removal of at least a portion of the one or more coatings; and recovering the polymeric substrate from the process mixture to mitigate re-deposition of the one or more coatings on the polymeric substrate.

In various embodiments, the one or more coatings may include an adhesive. The adhesive may include one or more of a cured/curable polymeric adhesive, a thermoformed thermoplastic, pressure-sensitive adhesive, hot melt adhesive, and the like. For example, the adhesive may include one or more of: a latex; a polyurethane; an acrylic, e.g., an acrylic co-polymer; a vinyl, e.g., a polyvinyl acetate; a thermoformed polyolefin, e.g., polyethylene; copolymers thereof; blends thereof; and the like. For example, the latex may be a natural latex or a synthetic latex, for example, a synthetic latex derived from styrene-butadiene (SBS). For example, the adhesive may include an adhesive sold under the tradename BOSTIK® (Bostik; Milwaukee, Wis.), e.g., BOSTIK® H20080. BOSTIK® H20080 may include a styrene-isoprene-styrene (SIS) polymer and a styrene-butadiene-styrene (SBS) polymer, e.g., a styrene copolymer. For example, the adhesive may include an adhesive sold under the tradename DyTac (Dyna-tech; Grafton, WV), e.g., DyTac 6154. DyTac 6154 may include a pressure-sensitive adhesive including a rubber-resin. For example, the adhesive may include an adhesive sold under the tradename COVINAX® (Franklin Adhesives & Polymers; Columbus, Ohio), e.g., COVINAX® 525-78. COVINAX® 525-78 may include a pressure-sensitive adhesive including an internally crosslinked tackified vinyl acrylic copolymer. The adhesive may include one or more of: a rubber-resin emulsion, a styrenic copolymer, and polyvinyl acetate. The one or more coatings may include, adhered to the polymeric substrate by the adhesive, one or more of: a woven textile, a nonwoven textile, a polymeric film, and a natural or synthetic rubber.

In some embodiments, the one or more coatings may include, for example, one or more of: a paint, an ink, a dye, a powder coat, a paper label, a plastic label, an adhesive, a barrier coating, a metalized coating, food, or a bio-coating. The bio-coating may be, for example, protein-based, oligosaccharide-based, and the like. The metalized coating may include a continuous film or metal particulates.

In various embodiments, the polymeric substrate may include one or more of: polyethylene (PE), low-density polyethylene (HDPE), high-density polyethylene (HDPE), polypropylene (PP), biaxially oriented polypropylene (BOPP), polycarbonate (PC), polyethyelene terephthalate (PET), polyethyelene terephthalate-glycerol modified (PET-G), polylactic acid (PLA), polystyrene (PS), polyvinyl acetate (PVA), nylon, copolymers and block copolymers thereof, mixtures thereof, and the like. The polymeric substrate may be corrugated. In some embodiments, it may be more difficult to remove the one or more coatings from a corrugated polymeric substrate than a non-corrugated polymeric substrate since, for example, the corrugated grooves may be less accessible. The polymeric substrate may be in pieces or particulates, for example, cut, shredded, or ground, e.g., as part of a recycling process. The polymeric substrate may be one or more of: recycled; virgin plastic; flexible; fibrous; mixtures thereof; and the like. The polymeric substrate may include a single layered or multilayered film. The polymeric substrate may include a plastic film or container material.

In various embodiments, the polymeric substrate may include two or more polymeric fractions. At least two of the polymeric fractions may be adhered via an adhesive. The method may include separating one or more polymeric fraction from the two or more polymeric fractions. Each of the polymeric fractions may independently include polyethylene (PE), low-density polyethylene (HDPE), high-density polyethylene (HDPE), polypropylene (PP), biaxially oriented polypropylene (BOPP), polycarbonate (PC), polyethylene terephthalate (PET), polyethylene terephthalate-glycerol modified (PET-G), polylactic acid (PLA), polystyrene (PS), polyvinyl acetate (PVA), nylon, copolymers and block copolymers thereof, mixtures thereof, or the like. For example, a polymeric substrate may include a polypropylene polymer fraction and polyethylene terephthalate polymer fraction. For example, a polymeric substrate may include a polypropylene polymer fraction and another polypropylene polymer fraction. For example, a polymeric substrate may include a polypropylene polymer fraction, a polyethylene terephthalate polymer fraction, and a nylon polymer fraction. For example, the polymeric substrate may include a polypropylene polymer fraction, a polyethylene polymer fraction, and a polyvinyl acetate polymer fraction.

In some embodiments, one or more of the polymeric fractions may be in the form of a corrugated material. One or more of the polymeric fractions may be in the form of a textile, e.g., woven or non-woven. One or more of the polymeric fractions may be in the form of a liner, e.g., of textile or of a polymer. The polymeric substrate may include polymeric fractions in the form of one or more of: a corrugated material, a textile, and a liner. For example, the polymeric substrate may include a corrugated polypropylene material and one or more polyethylene terephthalate textiles. The polymeric substrate may include a corrugated polypropylene material and a polyethylene liner. The polymeric substrate may include any combination of the polymeric fractions in the form of a corrugated material, a textile, and a liner.

In some embodiments, the polymeric fractions may to bound or adhered via an adhesive, e.g., any adhesive described herein.

In several embodiments of the method, the single-phase aqueous solution may include the inorganic base composition in any amount or composition described herein. For example, the single-phase aqueous solution may include the inorganic base composition in an amount effective to establish a hydroxide concentration in moles/liter (M) of about one or more of: 0.0125 M to 0.625 M; 0.025 M to 0.5 M; 0.025 M to 0.375 M; 0.025 M to 0.25 M; 0.025 M to 0.125 M; and 0.0625 M. The single-phase aqueous solution may include the inorganic base composition as sodium hydroxide in a weight percent concentration (w/w) with respect to the water of about 1%, or less than 1%, including any percentage greater than zero and less than 1 (w/w) %.

In some embodiments of the method, the single-phase aqueous solution may include the inorganic base composition in any amount or composition described herein. For example, the sulfoxylate composition may include a salt of hydroxymethylene sulfoxylate with an 10n of one of: an alkali metal, an alkali earth metal, and a transition metal. The sulfoxylate composition may include sodium hydroxymethylene sulfoxylate. The single-phase aqueous solution may include the sulfoxylate composition in a weight percentage (w/w) with respect to water of about one or more of: 0.05% to 5%, 0.05 to 2.5%, 0.1% to 2%, 0.15% to 1.5%, 0.2% to 1%, 0.3% to 0.7%, 0.4% to 0.6%, and 0.5%.

In various embodiments of the method, the single-phase aqueous solution may include one or more of a stable peroxygen composition and a monosaccharide salt in any amount or composition described herein. For example, the single-phase aqueous solution may include the stable peroxygen composition in a weight percent concentration (w/w) with respect to the water of about one or more of: 0.1% to 5%, 0.2% to 2.5%, 0.3 to 2%, 0.5% to 1.5%, 0.75% to 1.25%, and 1%. The stable peroxygen composition may include sodium percarbonate. The single-phase aqueous solution may include the monosaccharide salt in a weight percent concentrations (w/w) with respect to water of about one or more of: 0.1% to 5%, 0.2% to 2.5%, 0.3 to 2%, 0.5% to 1.5%, 0.75% to 1.25%, and 1%. The monosaccharide salt may include sodium gluconate.

In several embodiments of the method, the single-phase aqueous solution may include the surfactant composition in any amount or composition described herein. For example, the surfactant composition may include an alkylglycoside, each alkyl being independently selected from C₆-C₈ alkyl. The surfactant composition may include one or more of: capryl glucoside, decyl glucoside, deceth-5, and PPG-6-Laureth-3. The single-phase aqueous solution may include the surfactant composition in a weight percentage (w/w) with respect to the water of one or more of about: 0.005% to 5%, 0.01 to 4%, 0.05% to 3%, 0.1% to 2%, 0.5% to 1.5%, and 1%.

In various embodiments, a method for removing one or more coatings from a corrugated polymeric substrate is provided. The method may include providing a single-phase aqueous solution. The single-phase aqueous solution may include water; an inorganic base composition; and a surfactant composition. The single-phase aqueous solution may include one or more of a stable peroxygen composition, a monosaccharide salt, and a sulfoxylate composition. The method may include providing the corrugated polymeric substrate. The corrugated polymeric substrate may include one or more coatings. The method may include contacting the single-phase aqueous solution and the corrugated polymeric substrate to form a process mixture under conditions effective to remove at least a portion of the one or more coatings from the corrugated polymeric substrate.

In various embodiments, a process mixture is provided, as produced by any method described herein.

In various embodiments, the conditions effective to remove a portion of the one or more coatings from the corrugated polymeric substrate may include heating the process mixture. The process mixture may be heated may be heated at a temperature of about one or more of: between about 10° C. and about 100° C.; between about 10° C. and about 30° C. or between about 15° C. and 26° C. Alternatively, between about 65° C. and about 100° C.; between about 70° C. and about 100° C.; between about 75° C. and about 95° C.; between about 80° C. and about 90° C.; between about 80° C. and about 85° C.; about 85° C.; about 82° C.; or between about any two of the preceding values, or about any of the preceding values, for example, between about 60° C. and about 100° C. or about 85° C.

In several embodiments, the method may include providing the water in the single-phase aqueous composition in a weight ratio to the corrugated polymeric substrate of one or more of about: 4:1 to 32:1; 8:1 to 24:1; 10:1 to 20:1; 12:1 to 18:1; 14:1 to 18:1; 15:1 to 17:1; and 16:1. The method may include providing the water in the precursor single-phase aqueous composition in a weight ratio to the corrugated polymeric substrate of one or more of about: 4:1 to 32:1; 8:1 to 24:1; 10:1 to 20:1; 12:1 to 18:1; 14:1 to 18:1; 15:1 to 17:1; and 16:1.

In various embodiments, the method may include monitoring the process mixture for removal of at least a portion of the one or more coatings; and recovering the corrugated polymeric substrate from the process mixture to mitigate re-deposition of the one or more coatings on the corrugated polymeric substrate.

In various embodiments, the one or more coatings may include an adhesive, e.g., any adhesive described herein.

In some embodiments, the one or more coatings may include, for example, one or more of: a paint, an ink, a dye, a powder coat, a paper label, a plastic label, an adhesive, a barrier coating, a metalized coating, food, or a bio-coating. The bio-coating may be, for example, protein-based, oligosaccharide-based, and the like. The metalized coating may include a continuous film or metal particulates.

In various embodiments, the corrugated polymeric substrate may include one or more of: polyethylene (PE), low-density polyethylene (HDPE), high-density polyethylene (HDPE), polypropylene (PP), biaxially oriented polypropylene (BOPP), polycarbonate (PC), polyethyelene terephthalate (PET), polyethyelene terephthalate-glycerol modified (PET-G), polylactic acid (PLA), polystyrene (PS), polyvinyl acetate (PVA), nylon, copolymers and block copolymers thereof, mixtures thereof, and the like. In some embodiments, it may be more difficult to remove the one or more coatings from a corrugated polymeric substrate than a non-corrugated polymeric substrate since, for example, the corrugated grooves may be less accessible. The corrugated polymeric substrate may be in pieces or particulates, for example, cut, shredded, or ground, e.g., as part of a recycling process. The corrugated polymeric substrate may be one or more of: recycled; virgin plastic; flexible; fibrous; mixtures thereof; and the like. The corrugated polymeric substrate may include a single layered or multilayered film. The corrugated polymeric substrate may include a plastic film or container material.

In various embodiments, the corrugated polymeric substrate may include two or more polymeric fractions. At least two of the polymeric fractions may be adhered via an adhesive. The method may include separating one or more polymeric fraction from the two or more polymeric fractions. Each of the polymeric fractions may independently include polyethylene (PE), low-density polyethylene (HDPE), high-density polyethylene (HDPE), polypropylene (PP), biaxially oriented polypropylene (BOPP), polycarbonate (PC), polyethylene terephthalate (PET), polyethylene terephthalate-glycerol modified (PET-G), polylactic acid (PLA), polystyrene (PS), polyvinyl acetate (PVA), nylon, copolymers and block copolymers thereof, mixtures thereof, or the like. For example, a corrugated polymeric substrate may include a polypropylene polymer fraction and polyethylene terephthalate polymer fraction. For example, a corrugated polymeric substrate may include a polypropylene polymer fraction and another polypropylene polymer fraction. For example, a corrugated polymeric substrate may include a polypropylene polymer fraction, a polyethylene terephthalate polymer fraction, and a nylon polymer fraction. For example, the corrugated polymeric substrate may include a polypropylene polymer fraction, a polyethylene polymer fraction, and a polyvinyl acetate polymer fraction.

In some embodiments, one or more of the polymeric fractions may be in the form of a corrugated material. One or more of the polymeric fractions may be in the form of a textile, e.g., woven or non-woven. One or more of the polymeric fractions may be in the form of a liner, e.g., of textile or of a polymer. The corrugated polymeric substrate may include polymeric fractions in the form of one or more of: a corrugated material, a textile, and a liner. For example, the corrugated polymeric substrate may include a corrugated polypropylene material and one or more polyethylene terephthalate textiles. The corrugated polymeric substrate may include a corrugated polypropylene material and a polyethylene liner. The corrugated polymeric substrate may include any combination of the polymeric fractions in the form of a corrugated material, a textile, and a liner.

In some embodiments, the polymeric fractions may to bound or adhered via an adhesive, e.g., any adhesive described herein.

In several embodiments of the method, the single-phase aqueous solution may include the inorganic base composition in any amount or composition described herein. For example, the single-phase aqueous solution may include the inorganic base composition in an amount effective to establish a hydroxide concentration in moles/liter (M) of about one or more of: 0.0125 M to 0.625 M; 0.025 M to 0.5 M; 0.025 M to 0.375 M; 0.025 M to 0.25 M; 0.025 M to 0.125 M; and 0.0625 M. The single-phase aqueous solution may include the inorganic base composition as sodium hydroxide in a weight percent concentration (w/w) with respect to the water of about 1%.

In some embodiments of the method, the single-phase aqueous solution may include the inorganic base composition in any amount or composition described herein. For example, the sulfoxylate composition may include a salt of hydroxymethylene sulfoxylate with an 10n of one of: an alkali metal, an alkali earth metal, and a transition metal. The sulfoxylate composition may include sodium hydroxymethylene sulfoxylate. The single-phase aqueous solution may include the sulfoxylate composition in a weight percentage (w/w) with respect to water of about one or more of: 0.05% to 5%, 0.05 to 2.5%, 0.1% to 2%, 0.15% to 1.5%, 0.2% to 1%, 0.3% to 0.7%, 0.4% to 0.6%, and 0.5%.

In various embodiments of the method, the single-phase aqueous solution may include one or more of a stable peroxygen composition and a monosaccharide salt in any amount or composition described herein. For example, the single-phase aqueous solution may include the stable peroxygen composition in a weight percent concentration (w/w) with respect to the water of about one or more of: 0.1% to 5%, 0.2% to 2.5%, 0.3 to 2%, 0.5% to 1.5%, 0.75% to 1.25%, and 1%. The stable peroxygen composition may include sodium percarbonate. The single-phase aqueous solution may include the monosaccharide salt in a weight percent concentrations (w/w) with respect to water of about one or more of: 0.1% to 5%, 0.2% to 2.5%, 0.3 to 2%, 0.5% to 1.5%, 0.75% to 1.25%, and 1%. The monosaccharide salt may include sodium gluconate.

In several embodiments of the method, the single-phase aqueous solution may

include the surfactant composition in any amount or composition described herein. For example, the surfactant composition may include an alkylglycoside, each alkyl being independently selected from C₆-C₈ alkyl. The surfactant composition may include one or more of: capryl glucoside, decyl glucoside, deceth-5, and PPG-6-Laureth-3. The single-phase aqueous solution may include the surfactant composition in a weight percentage (w/w) with respect to the water of one or more of about: 0.005% to 5%, 0.01 to 4%, 0.05% to 3%, 0.1% to 2%, 0.5% to 1.5%, and 1%.

In various embodiments, a kit for removing one or more coatings from a corrugated polymeric substrate is provided. The kit may include a single-phase aqueous solution. The single-phase aqueous solution may include a surfactant composition and a sulfoxylate composition. The kit may include an inorganic base composition. In several embodiments, the kit may include any aspect of the single-phase aqueous solution described herein. The kit may include any aspect of the surfactant composition, sulfoxylate composition or inorganic base composition described herein. The kit may include instructions. The instructions may direct a user to add the inorganic base composition to the single-phase aqueous solution. The instructions may direct a user to provide a corrugated polymeric substrate. The corrugated polymeric substrate may include one or more coatings. The instructions may direct a user to contact the single-phase aqueous solution and the corrugated polymeric substrate to form a process mixture under conditions effective to remove atleast a portion of the one or more coatings from the corrugated polymeric substrate. The instructions may direct a user to conduct any aspect of the methods described herein.

### EXAMPLES

### Example 1

Approximately 5.4 kg water was added to a mixing tank and heated to about 82° C.

While stirring at approximately 1200 RPM, 1% (w/w) of 50% (w/v) solution of NaOH, 1% (w/w) sodium percarbonate, 1% (w/w) sodium gluconate, and 0.3% (w/w) DEHYPOUND® ADVANCED surfactant (BASF Corporation, Florham Park, NJ) were added to the mixing tank. Approximately 680 g of a blue corrugated polypropylene (PP) sheet lined on each side with a blue polyethylene terephthalate (PET) fabric (Henkel; Rocky Hill, Conn.) was added as a 2.54 cm ground material to provide a process mixture (pH=11.33). The fabric and corrugated sheet were adhered via BOSTIK® H20080 (Bostik, Milwaukee, Wis.) adhesive. After 10-12 h, the PP and PET were subjected to float-sink separation. It was determined via density analysis that >98.5% of the PET fabric had been separated from the PP sheet material. The corrugated PP material retained much of the adhesive residue which complicated efforts to feed the PP through an extruder.

About 454 g of the separated corrugated PP material was combined at about 82° C. with about 5.4 kg water, 1% (w/w) of 50% (w/v) solution of NaOH, 0.5% (w/w) BRUGGOLITE® FF6M (Bruggemann Chemical; Newtown Square, Pa.), and 0.3% (w/w) DEHYPOUND® ADVANCED surfactant (BASF Corporation, Florham Park, N.J.). The process mixture (pH=11.27) was stirred at about 1200 RPM. After about 8-10 h, the corrugated PP material was determined to be >99.5% free of the adhesive residue. The de-coated corrugated PP regrind was further extruded.

### Example 2

About 5.4 kg water, 1% (w/w) of 50% (w/v) solution of NaOH, 1% (w/w) sodium gluconate, and 0.3% (w/w) DEHYPOUND® ADVANCED were added to a vessel and brought to about 82° C. while being stirred at about 1000 RPM (pH=11.35). About 680 g of colorlesscorrugated TYVEK® laminate (Orbis; Oconomowoc, Wis.) was added to the vessel. The laminate included a corrugated PP sheet having PE liners adhered to both sides of the sheet with COVINAX® 525-78 (Franklin Adhesives & Polymers; Columbus, Ohio) adhesive. After about 2 h, the PE liners were completely removed from the corrugated PP and the PP was free of adhesive residue.

### Example 3

About 5.4 kg water, 1% (w/w) of 50% (w/v) solution of NaOH, 1% (w/w) sodium gluconate, and 0.3% (w/w) DEHYPOUND® ADVANCED were added to a vessel and brought to about 82° C. while being stirred at about 1000 RPM (pH=11.35). About 680 g of black corrugated green brush poly laminate (Orbis; Oconomowoc, Wis.) was added to the vessel. The laminate included a black corrugated PP sheet with green PET fabric adhered to each side with DyTac 6154 (Dyna-tech; Grafton, WV) adhesive. After about 2 h the PET fabric was fully removed from the corrugated PP sheet and separated via sink-float. No visible adhesive remained.

### Example 4

About 186 kg water, 0.2% (w/w) of 50% (w/v) solution of NaOH, 0.1% (w/w %) of DEHYPOUND® ADVANCED were added into a vessel and brought to about 15° C. to about 26° C. (about 60°F. to about 80°F.) water. About 50 lb (pounds) of blue corrugated SPUNTEK® laminate was added to the vessel. The laminate included a white or a black colored corrugated sheet with Blue PP fabric laminate on one side on few corrugated sheets and two sided fabric laminate on few corrugated sheets. After about 2.5 hr the PP laminate is fully separated from the corrugated sheet with zero to very minimal friction on the corrugate sheets. The PP fabric laminate can be peeled off manually or can be easily separated by an automated process. These PP corrugated sheets are completely separated from the PP fabric laminate and adhesive coating after treatment.

### Example 5

About 186 kg water, 0.05% (w/w %) of DEHYPOUND® ADVANCED were added into a vessel and brought to about 15° C. to about 26° C. (about 60° F. to about 80° F.) water. About 100 lb of blue corrugated Green Brushed Poly Laminate was added to the vessel. The laminate included a white or a black colored corrugated sheet with Green PET fabric laminate on one side on few corrugated sheets and two side fabric laminate on few corrugated sheets. After about in less than 15 min the PET laminate is fully separated from the corrugated sheet with zero to very minimal friction on the corrugate sheets. The PP fabric laminate can be peeled off manually or can be easily separated by an automated process. These PP corrugated sheets are completely separated from the PET fabric laminate and adhesive coating after treatment.

### Example 6

About 186 kg water, 0.2% (w/w) of 50% (w/v) solution of NaOH, 0.1% (w/w %) of DEHYPOUND® ADVANCED were added into a vessel and brought to about 15° C. to about 26° C. (about 60° F. to about 80° F.) water. About 50 lb of blue corrugated TYVEK® Laminate was added to the vessel. The laminate included a white or a black colored corrugated sheet with a white PE laminate on one side on few corrugated sheets and two side laminate on few corrugated sheets. After about 2 hr the PE laminate is fully separated from the corrugated sheet with zero to very minimal friction on the corrugate sheets. The PE laminate can be peeled off manually or can be easily separated by an automated process. These corrugated PP sheets are completely separated from the PE laminate and adhesive coating after treatment.

To the extent that the term “includes” or “including” is used in the specification or the claims, it is intended to be inclusive in a manner similar to the term “comprising” as that term is interpreted when employed as a transitional word in a claim. Also, to the extent that the terms “in” or “into” are used in the specification or the claims, it is intended to additionally mean “on” or “onto.” To the extent that the term “selectively” is used in the specification or the claims, it is intended to refer to a condition of a component wherein a user of the apparatus may activate or deactivate the feature or function of the component as is necessary or desired in use of the apparatus. To the extent that the terms “operatively coupled” or “operatively connected” are used in the specification or the claims, it is intended to mean that the identified components are connected in a way to perform a designated function. To the extent that the term “substantially” is used in the specification or the claims, it is intended to mean that the identified components have the relation or qualities indicated with degree of error as would be acceptable in the subject industry.

As used in the specification and the claims, the singular forms “a,” “an,” and “the” include the plural unless the singular is expressly specified. For example, reference to “a compound” may include a mixture of two or more compounds, as well as a single compound.

As used herein, the term “about” in conjunction with a number is intended to include ±10% of the number. In other words, “about 10” may mean from 9 to 11.

As used herein, the terms “optional” and “optionally” mean that the subsequently described circumstance may or may not occur, so that the description includes instances where the circumstance occurs and instances where it does not.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses

without departing from the spirit or scope of the general inventive concept.

As used herein, “substituted” refers to an organic group as defined below (e.g., an alkyl group) in which one or more bonds to a hydrogen atom contained therein may be replaced by a bond to non-hydrogen or non-carbon atoms. Substituted groups also include groups in which one or more bonds to a carbon(s) or hydrogen(s) atom may be replaced by one or more bonds, including double or triple bonds, to a heteroatom. A substituted group may be substituted with one or more substituents, unless otherwise specified. In some embodiments, a substituted group may be substituted with 1, 2, 3, 4, 5, or 6 substituents. Examples of substituent groups include: halogens (e.g., F, Cl, Br, and I); hydroxyls; alkoxy, alkenoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; or nitriles (e.g., CN). A “per”-substituted compound or group is a compound or group having all or substantially all substitutable positions substituted with the indicated substituent. For example, 1,6-diiodo perfluoro hexane indicates a compound of formula C₆F₁₂1₂, where all the substitutable hydrogens have been replaced with fluorine atoms.

Substituted ring groups such as substituted cycloalkyl, aryl, heterocyclyl and heteroaryl groups also include rings and ring systems in which a bond to a hydrogen atom may be replaced with a bond to a carbon atom. Substituted cycloalkyl, aryl, heterocyclyl and heteroaryl groups may also be substituted with substituted or unsubstituted alkyl, alkenyl, and alkynyl groups as defined below.

Alkyl groups include straight chain and branched chain alkyl groups having from 1 to 12 carbon atoms, and typically from 1 to 10 carbons or, in some examples, from 1 to 8, 1 to 6, or 1 to 4 carbon atoms. Examples of straight chain alkyl groups include groups such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tent-butyl, neopentyl, isopentyl, and 2,2-dimethylpropyl groups. Representative substituted alkyl groups may be substituted one or more times with substituents such as those listed above and include, without limitation, haloalkyl (e.g., trifluoromethyl), hydroxyalkyl, thioalkyl, aminoalkyl, alkylaminoalkyl, dialkylaminoalkyl, alkoxyalkyl, or carboxyalkyl.

Cycloalkyl groups include mono-, bi- or tricyclic alkyl groups having from 3 to 12 carbon atoms in the ring(s), or, in some embodiments, 3 to 10, 3 to 8, or 3 to 4, 5, or 6 carbon atoms. Exemplary monocyclic cycloalkyl groups include, but are not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments, the number of ring carbon atoms ranges from 3 to 5, 3 to 6, or 3 to 7. Bi- and tricyclic ring systems include both bridged cycloalkyl groups and fused rings, such as, but not limited to, bicyclo[2.1.1]hexane, adamantyl, or decalinyl. Substituted cycloalkyl groups may be substituted one or more times with non-hydrogen and non-carbon groups as defined above. However, substituted cycloalkyl groups also include rings that may be substituted with straight or branched chain alkyl groups as defined above. Representative substituted cycloalkyl groups may be mono-substituted or substituted more than once, such as, but not limited to, 2,2-, 2,3-, 2,4- 2,5- or 2,6-disubstituted cyclohexyl groups, which may be substituted with substituents such as those listed above.

Aryl groups may be cyclic aromatic hydrocarbons that do not contain heteroatoms. Aryl groups herein include monocyclic, bicyclic and tricyclic ring systems. Aryl groups include, but are not limited to, phenyl, azulenyl, heptalenyl, biphenyl, fluorenyl, phenanthrenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. In some embodiments, the aryl groups may be phenyl or naphthyl. Although the phrase “aryl groups” may include groups containing fused rings, such as fused aromatic-aliphatic ring systems (e.g., indanyl or tetrahydronaphthyl), “aryl groups” does not include aryl groups that have other groups, such as alkyl or halo groups, bonded to one of the ring members. Rather, groups such as tolyl may be referred to as substituted aryl groups. Representative substituted aryl groups may be mono-substituted or substituted more than once. For example, monosubstituted aryl groups include, but are not limited to, 2-, 3-, 4-, 5-, or 6-substituted phenyl or naphthyl, which may be substituted with substituents such as those above.

Aralkyl groups may be alkyl groups as defined above in which a hydrogen or carbon bond of an alkyl group may be replaced with a bond to an aryl group as defined above. In some embodiments, aralkyl groups contain 7 to 16 carbon atoms, 7 to 14 carbon atoms, or 7 to 10 carbon atoms. Substituted aralkyl groups may be substituted at the alkyl, the aryl or both the alkyl and aryl portions of the group. Representative aralkyl groups include but are not limited to benzyl and phenethyl groups and fused (cycloalkylaryl)alkyl groups such as 4-indanylethyl. Substituted aralkyls may be substituted one or more times with substituents as listed above.

Groups described herein having two or more points of attachment (e.g., divalent, trivalent, or polyvalent) within the compound of the technology may be designated by use of the suffix, “ene.” For example, divalent alkyl groups may be alkylene groups, divalent aryl groups may be arylene groups, divalent heteroaryl groups may be heteroarylene groups, and so forth. In particular, certain polymers may be described by use of the suffix “ene” in conjunction with a term describing the polymer repeat unit.

Alkoxy groups may be hydroxyl groups (—OH) in which the bond to the hydrogen atom may be replaced by a bond to a carbon atom of a substituted or unsubstituted alkyl group as defined above. Examples of linear alkoxy groups include, but are not limited to, methoxy, ethoxy, propoxy, butoxy, pentoxy, or hexoxy. Examples of branched alkoxy groups include, but are not limited to, isopropoxy, sec-butoxy, tent-butoxy, isopentoxy, or isohexoxy. Examples of cycloalkoxy groups include, but are not limited to, cyclopropyloxy, cyclobutyloxy, cyclopentyloxy, or cyclohexyloxy. Representative substituted alkoxy groups may be substituted one or more times with substituents such as those listed above.

The various aspects and embodiments disclosed herein are for purposes of illustration and are not intended to be limiting, with the true scope and spirit being indicated by the following claims.

1. A single-phase aqueous solution for removing one or more coatings from a polymeric substrate, comprising:
water;
an inorganic base composition being present in an amount effective to establish a hydroxide concentration in moles/liter (M) of about 0.0125 M to 0.625 M or the base composition comprising sodium hydroxide in a weight percent concentration (w/w) with respect to the water of about 1%;
a sulfoxylate composition; and
a surfactant composition.

2. The single-phase aqueous solution of claim 1, the sulfoxylate composition comprising a salt of hydroxymethylene sulfoxylate with an 10n of one of: an alkali metal, an alkali earth metal, and a transition metal.

3. The single-phase aqueous solution of claim 1, the sulfoxylate composition being present in a weight percentage (w/w) with respect to water of about one or more of: 0.05% to 5%, 0.05 to 2.5%, 0.1% to 2%, 0.15% to 1.5%, 0.2% to 1%, 0.3% to 0.7%, 0.4% to 0.6%, and 0.5%.

4. The single-phase aqueous solution of claim 1, further comprising one or more of a stable peroxygen composition and a monosaccharide salt.

5. The single-phase aqueous solution of claim 1, the stable peroxygen composition comprising sodium percarbonate in a weight percent concentration (w/w) with respect to the water of about one or more of: 0.1% to 5%, 0.2% to 2.5%, 0.3 to 2%, 0.5% to 1.5%, 0.75% to 1.25%, and 1%.

6. The single-phase aqueous solution of claim 1, comprising the monosaccharide salt comprising sodium gluconate in a weight percent concentrations (w/w) with respect to water of about one or more of: 0.1% to 5%, 0.2% to 2.5%, 0.3 to 2%, 0.5% to 1.5%, 0.75% to 1.25%, and 1%.

7. The single-phase aqueous solution of claim 1, the surfactant composition comprising an alkylglycoside, each alkyl being independently selected from C₆-C₈ alkyl.

8. The single-phase aqueous solution of claim 1, the surfactant composition comprising one or more of: capryl glucoside, decyl glucoside, deceth-5, and PPG-6-Laureth-3.

9. The single-phase aqueous solution of claim 1, the surfactant composition being present in a weight percentage (w/w) with respect to the water of one or more of about: 0.005% to 5%, 0.01 to 4%, 0.05% to 3%, 0.1% to 2%, 0.5% to 1.5%, and 1%.

10. A method for removing one or more coatings from a polymeric substrate or a corrugated polymeric substrate, the method comprising:
providing a single-phase aqueous solution comprising:
water;
an inorganic base composition being present in an amount effective to establish a hydroxide concentration in moles/liter (M) of about 0.0125 M to 0.625 M or the base composition comprising sodium hydroxide in a weight percent concentration (w/w) with respect to the water of about 1%;
a sulfoxylate composition; and
a surfactant composition;
providing a polymeric substrate, the polymeric substrate comprising one or more coatings; and
contacting the single-phase aqueous solution and the polymeric substrate to form
a process mixture under conditions effective to remove at least a portion of the one or more coatings from the polymeric substrate.

11. The method of claim 10, further comprising:
providing a precursor single-phase aqueous solution, the precursor single-phase aqueous solution comprising: water; a precursor inorganic base composition; one or more of a precursor stable peroxygen composition and a precursor monosaccharide salt;
and a precursor surfactant composition;
prior to contacting the single-phase aqueous solution and the polymeric substrate to form the process mixture:
contacting the precursor single-phase aqueous solution to the polymeric substrate comprising the one or more coatings to form a precursor process mixture under conditions effective to remove at least a portion of the one or more coatings from the polymeric substrate; and
separating the polymeric substrate from the precursor process mixture.

12. The method of claim 10, the conditions effective to remove a portion of the one or more coatings from the polymeric substrate comprising heating the process mixture at a temperature of about 10° C. to 100° C.

13. The method of claim 10, comprising providing the water in a weight ratio to the polymeric substrate of one or more of about: 4:1 to 32:1; 8:1 to 24:1; 10:1 to 20:1; 12:1 to 18:1; 14:1 to 18:1; 15:1 to 17:1; and 16:1.

14. The method of claim 10, further comprising monitoring the process mixture for removal of at least a portion of the one or more coatings; and recovering the polymeric substrate from the process mixture to mitigate re-deposition of the one or more coatings on the polymeric substrate.

15. The method of claim 10, the one or more coatings comprising an adhesive comprising one or more of: a rubber-resin emulsion, a styrenic copolymer, and polyvinyl acetate.

16. The method of claim 15, the one or more coatings further comprising, adhered to the polymeric substrate by the adhesive, one or more of: a woven textile, a nonwoven textile, a polymeric film, and a natural or synthetic rubber.

17. The method of claim 10, the polymeric substrate comprising one or more of:
polyethylene (PE), low-density polyethylene (HDPE), high-density polyethylene (HDPE), polypropylene (PP), biaxially oriented polypropylene (BOPP), polycarbonate (PC), polyethylene terephthalate (PET), polyethylene terephthalate-glycerol modified (PET-G), polylactic acid (PLA), and polystyrene (PS).

18. The method of claim 10, the single-phase aqueous solution comprising sodium hydroxymethylene sulfoxylate in a weight percentage (w/w) with respect to water of about one or more of: 0.05% to 5%, 0.05 to 2.5%, 0.1% to 2%, 0.15% to 1.5%, 0.2% to 1%, 0.3% to 0.7%, 0.4% to 0.6%, and 0.5%.

19. The method of claim 10, the single-phase aqueous solution further comprising one or more of: a stable peroxygen composition comprising sodium percarbonate and a monosaccharide salt.

20. A kit for making a single-phase aqueous solution for removing one or more coatings from a polymeric substrate, comprising:
a single-phase aqueous solution, comprising a surfactant composition, and a sulfoxylate composition comprising sodium hydroxymethylene sulfoxylate;
an inorganic base composition being present in an amount effective to establish a hydroxide concentration in moles/liter (M) of about 0.0125 M to 0.625 M or the base composition comprising sodium hydroxide in a weight percent concentration (w/w) with respect to the water of about 1%;
and instructions, the instructions directing a user to:
add the inorganic base composition, to the single-phase aqueous solution;
provide a polymeric substrate, the polymeric substrate comprising one or more coatings; and
contact the single-phase aqueous solution and the polymeric substrate to form a process mixture under conditions effective to remove at least a portion of the one or more coatings from the polymeric substrate.
